(19) United States
(12) Patent Application Publication
(10) Pub. No.: US 2024/0307970 A1
(43) Pub. Date: Sep. 19, 2024

(54) An apparatus and method for producing an object by means of additive manufacturing

(71) Applicant: Additive Industries B.V., Eindhoven (NL)

(72) Inventor: Mark Alan Beard, Eindhoven (NL)

(21) Appl. No.: 18/577,056

(22) PCT Filed: Jul. 6, 2022
(86) PCT No.: PCT/NL2022/050385

§ 371 Date: Jan. 5, 2024

(30) Foreign Application Priority Data
Jul. 8, 2021 (NL) 2028668

(51) Int. Cl. B22F 12/90; B22F 10/28; B22F 10/366; B22F 10/38; B33Y 10/00; B33Y 30/00

(52) U.S. Cl. CPC B22F 12/90; B22F 10/28; B22F 10/366; B22F 10/385; B22F 2999/00; B33Y 10/00; B33Y 30/00

(57) ABSTRACT

An apparatus and a method using said apparatus for producing an object by means of additive manufacturing layer by layer in a layer sequence, said apparatus comprising:
a process chamber for receiving a bath of powdered material which can be solidified by exposure to electromagnetic radiation;
a support for positioning a part of said object in relation to a surface level of said bath of powdered material;
a solidifying device arranged for generating a beam of electromagnetic radiation for solidifying a selective part of a layer of said powdered material;
a deflection device arranged for moving said beam of electromagnetic radiation along said surface level; and
a control device arranged for controlling said solidifying device and said deflection device, during solidification of said selective part of said layer, taking into account a first section thermal resistance for conducting heat away from a first section of said selective part of said layer and a second section thermal resistance, that is higher than said first section thermal resistance, for conducting heat away from a second section of said selective part of said layer. A method of manufacturing an object by means of additive manufacturing.

According to a first aspect, the present disclosure relates to an apparatus for producing an object by means of additive manufacturing layer by layer in a layer sequence.

According to a second aspect, the present disclosure relates to a method of manufacturing an object by means of additive manufacturing layer by layer in a layer sequence.

The apparatus according to the first aspect of the present disclosure comprises:
a process chamber for receiving a bath of powdered material which can be solidified by exposure to electromagnetic radiation;
a support for positioning a part of said object in relation to a surface level of said bath of powdered material;
a solidifying device arranged for generating a beam of electromagnetic radiation for solidifying a selective part of a layer of said powdered material; and
a deflection device arranged for moving said beam of electromagnetic radiation along said surface level.

3D printing or additive manufacturing refers to any of various processes for manufacturing a three-dimensional object in which material is joined or solidified under computer control to create a three-dimensional object, with material being added together, typically layer by layer.

One of the challenges in the manufacturing of three dimensional objects, in particular in additive manufacturing of metal objects, is how to realize relative low manufacturing costs while allowing to realize a relative high product quality.

It is an object to provide an apparatus and a method that allows to realize relative low manufacturing costs while allowing to realize a relative high product quality.

This object is achieved by the apparatus according to the present disclosure, wherein the apparatus comprises a control device arranged for controlling said solidifying device and said deflection device, during solidification of said selective part of said layer, taking into account a first section thermal resistance for conducting heat away from a first section of said selective part of said layer and a second section thermal resistance, that is higher than said first section thermal resistance, for conducting heat away from a second section of said selective part of said layer.

The present disclosure relies at least partly on the insight that for the manufacturing of three dimensional objects, in particular in additive manufacturing of metal objects, supports may be required for supporting parts of the object that are supported by a relative small number of layers of solidified material of the bath of powdered material or are supported by the powder material of the previous layer of powdered material. This may for instance occur when a part of the object extends in a direction having a horizontal component that is equal to or larger than a vertical component. These supports are generally used to enable overhanging features to be built and also to allow heat to be conducted away from the overhanging feature of the object. These supports add cost to remove and are a barrier to unlocking the full design possibilities of additive manufacturing, for example where supports inside the object are needed, but are impossible to remove after completion of the object.

By providing the apparatus with the control device according to the first aspect of the present disclosure, the manufacturing of the object is conducted taking into account thermal resistance for conducting heat away. This allows for a relative good heat control and thereby avoids, or at least significantly reduces, the need for supports. It is noted that without a relative good heat control in the absence of supports effects may occur such as warping of parts of the object, growth of the object above the surface level of the bath of powdered material and unintended change of material properties. In other words, the control unit is arranged for controlling the rate of heat flow and scanning of the beam of electromagnetic radiation such that undesired deformation, microstructures are avoided and relative large overhanging features may be realised.

Preferably, said control device is further arranged for controlling said deflection device, during solidification of said selective part of said layer, such that said solidifying is progressing from said first section to said second section. By solidifying the first section of the selective part of the layer, the first section thermal resistance is reduces. Reducing the first thermal resistance may be beneficial for reducing the second section thermal resistance. A reduced second section thermal resistance increases the ability to conduct heat away from the second section, thereby allowing a relative short processing time while allowing to realize a relative high product quality. In other words, progressing from the first section to the second section avoids, or at least reduces, solidification of sections where heat may not be easily conducted away.

In this regard, control device is arranged for controlling said deflection device such that said solidifying is progressing from said first section to said second section using a zig-zig or a zig-zag movement of said beam of electromagnetic radiation. Within the context of the present disclosure, a zig-zig movement of the beam is to be understood as a scanning movement wherein the solidifying process for each line scan starts at the same side, whereas a zig-zag movement refers to a movement wherein the solidifying process for subsequent movements starts at opposite sides.

In an embodiment of the apparatus according to the present disclosure, said control device is further arranged for controlling said deflection device, during solidification of said selective part of said layer, such that said beam of electromagnetic radiation in said first section is moved over a first distance before changing a movement direction of said beam of said electromagnetic radiation and such that said beam of electromagnetic radiation in said second section is moved over a second distance, that is longer than said first distance, before changing a movement direction of said beam of said electromagnetic radiation. A second distance that is longer than the first distance is beneficial for increasing time between thermal inputs for a section by using relative long scan paths. This is beneficial for realising a relative high product quality.

In this regard, it is beneficial if said second distance exceeds a predetermined distance. The second distance exceeding a predetermined distance is beneficial for, at a given movement speed of the beam of electromagnetic radiation, setting a threshold time period between thermal inputs for said second section. This is beneficial for realising a relative high product quality.

Preferably, said control device is further arranged for controlling said deflection device, during solidification of said selective part of said layer, such that a movement of said beam of electromagnetic radiation in said first section is delayed, by a first delay, when changing a movement direction of said beam of electromagnetic and such that a movement of said beam of electromagnetic radiation in said second section is delayed, by a second delay, that is longer than said first delay, when changing a movement direction of said beam of electromagnetic radiation. A second delay that is longer than the first delay is beneficial for increasing time between thermal inputs for a section by using relative long delays. A relative long delay allows more heat to be conducted away from the second section. This is beneficial for realising a relative high product quality.

In this regard, it is preferred if said second delay exceeds a predetermined delay. The second delay exceeding a predetermined delay is beneficial for setting a threshold time period between thermal inputs for said second section and allowing heat to be conducted away from the second section. This is beneficial for realising a relative high product quality.

It is advantageous, if said second delay is dependent on said second section thermal resistance, preferably, said second delay increases as a function of said second section thermal resistance. A relative long delay allows more heat to be conducted away when the second section thermal resistance is relatively high. This is beneficial for realising a relative high product quality.

Preferably, during said second delay, said deflection device is moving said beam of electromagnetic radiation along said surface level at said first section or a further section of said selective part of said layer.

It is advantageous, if said control device is further arranged for controlling said deflection device, during solidification of said selective part of said layer, such that subsequent movements of said beam of electromagnetic radiation in said first section enclose an angle, wherein said movement of said beam of electromagnetic radiation in said first section is delayed, when said angle is smaller than a predetermined angle.

It is beneficial, if said control device is further arranged for controlling said deflection device, during solidification of said selective part of said layer, such that subsequent movements in different directions of said beam of electromagnetic radiation in said first section enclose a first angle and such that subsequent movements in different directions of said beam of electromagnetic radiation in said second section enclose a second angle that is larger than said first angle. This is beneficial for reducing the heat rate input in parts of said second section and thereby realising a relative high product quality.

In this regard, it is preferable if said second angle exceeds a further predetermined angle.

In an embodiment of the apparatus according to the present disclosure, said first and second section thermal resistance are based on a thermal resistance of said bath of material and a thermal resistance of said part of said object. The present disclosure relies at least partly on the insight that the thermal resistance of the powdered material may differ significantly from the thermal resistance of the part of the object, i.e. powdered material after being molten by the beam of electromagnetic radiation solidified during subsequent cooling down and thereby forming part of the object. During manufacturing of the object, the local thermal resistance of a part of the object or bath of material may change due to local solidification, by the solidification device, of the powdered material and thereby potentially affecting the quality of the object.

It is advantageous, if said control device is further arranged for controlling said solidifying device and said deflection device, during solidification of said selective part of said layer, such that an energy density of said beam of electromagnetic radiation for said second section is lower than for said first section. This is beneficial for realising a lower heat rate input in the second section that is smaller than a heat rate input in the first section and thereby for realising an object having a relative high quality.

Preferably, said energy density for said second section is below a predetermined energy density. This is beneficial for realising a heat rate input in the second section that is below a predetermined threshold thereby for realising an object having a relative high quality.

Preferably, a spot shape, spot size and/or hatch spacing of said beam of electromagnetic radiation for said first section is different from said second section. This is beneficial for realising a lower heat rate input in the second section that is smaller than a heat rate input in the first section and thereby for realising an object having a relative high quality.

Preferably, a hatch spacing of said beam of electromagnetic radiation is substantially the same, preferably the same for said first section and said second section. This is beneficial for realising a method that allows to realize relative low manufacturing costs while allowing to realize a relative high product quality. Within the context of the present disclosure a hatching distance is to be understood as distance between centre lines of neighbouring scan paths of the beam of electromagnetic radiation.

Preferably, a ratio of a hatch spacing of said beam of electromagnetic radiation in said first section and said second section is within a range of 0.25 and 1.0, preferably, within a range of 0.25 to 0.75, more preferably, 0.25 to 0.5.

It is beneficial, if said apparatus is arranged for realizing a gas flow in a gas flow direction within said process chamber and wherein said control device is further arranged for controlling said solidifying device and said deflection device, during solidification of said selective part of said layer, taking into account said gas flow direction of said gas flow in said process chamber. It is noted that a gas flow in the process chamber in a predetermined direction is generally used for instance for removing fumes and airborne particles from the selective part of the layer. It is further noted that it is known to take the direction of the gas flow into account during manufacturing of the object to avoid, or at least significantly reducing, the risk of interference of fumes with the beam of electromagnetic radiation that may cause an undesired variation of process parameters at the surface level of the bath of powdered material.

The present disclosure relies at least partly on the insight that the gas flow direction may not be changed fast when changing a movement direction of the beam of electromagnetic radiation. This may cause the beam of electromagnetic radiation going through the fumes and thereby causing a relative low heat rate input in the first or second section. The apparatus according to the present disclosure is preferably arranged for taking into account the gas flow direction and controlling, by the control device, the solidifying device and the deflection device such that, during manufacturing of the object, a predetermined heat rate input in the first section and the second section is realised independent of a movement direction of the beam of electromagnetic radiation along the surface level. This is beneficial for allowing for a relative short processing time while realizing an object having a relative high quality.

Preferably, said control device is arranged for controlling said solidifying device and/or said deflection device, during solidification of said selective part of said layer, taking into account a number of layers of said part of said object supporting said first section and said second section of said selective part of said layer. It is noted that a relative low number of layers of said part of said object, below said surface level of said second section of said selective part of said layer, may result in a relative high second section thermal resistance.

In this regard, it is beneficial if said control device is arranged for controlling said solidifying device and/or said deflection device, during solidification of said selective part of said layer, taking into account a threshold value of a predetermined number of layers.

Preferably, said control device is further arranged for controlling said deflection device, during solidification of said selective part of said layer, such that said beam of electromagnetic radiation, in said second section is moved along said surface level in a direction away from said first section.

It is advantageous if said control device is further arranged for controlling said solidifying device and said deflection device, during solidification of said selective part of said layer, such that a heat flow in said second section of said selective part of said layer is lower than or equal to a heat flow in said second section of said selective part.

It is beneficial if said control device is further arranged for controlling said solidifying device and said deflection device, during solidification of said selective part of said layer, such that a maximum temperature of said second section is lower than or equal to a maximum temperature of said first section.

In an embodiment of the apparatus according to the present disclosure, said apparatus further comprises:
a detection arrangement arranged for detecting a temperature of said selective part of said layer;
a processor unit arranged for receiving said detected temperature and further arranged for calculating updated process settings of said solidifying device and/or deflection device for solidifying said selective part of said layer based on said detected temperatures;
   wherein said control device is further arranged for receiving said updated process settings and controlling said solidifying device and deflection device for solidifying said selective part of said layer in accordance with said updated process settings.

According to the second aspect, the present disclosure relates to a method of manufacturing an object by means of additive manufacturing layer by layer in a layer sequence, using an apparatus comprising
a process chamber for receiving a bath of powdered material which can be solidified by exposure to electromagnetic radiation;
a support for positioning a part of said object in relation to a surface level of said bath of powdered material;
a solidifying device arranged for generating a beam of electromagnetic radiation for solidifying a selective part of a layer of said powdered material;
a deflection device arranged for moving said beam of electromagnetic radiation along said surface level; and
a control device arranged for controlling said solidifying device and said deflection device, during solidification of said selective part of said layer, taking into account a first section thermal resistance for conducting heat away from a first section of said selective part of said layer and second section thermal resistance, that is higher than said first section thermal resistance, for conducting heat away from a second section of said selective part of said layer;
   wherein said method comprises the steps of:
solidifying, by said solidifying device, said selective part of said layer of said powdered material;
moving, by said deflection device, said beam of electromagnetic radiation along said surface level; and
controlling, by said control device, said solidifying device and said deflection device, taking into account a first section thermal resistance for conducting heat away from a first section of said selective part of said layer and second section thermal resistance, that is higher than said first section thermal resistance, for conducting heat away from a second section of said selective part of said layer.

Embodiments of the method according to the second aspect correspond to embodiments of the apparatus according to the first aspect of the present disclosure. The advantages of the method according to the second aspect correspond to advantages of the apparatus according to first aspect of the present disclosure presented previously.

In this regard, it is beneficial if said control device is further arranged for controlling said deflection device, during solidification of said selective part of said layer, such that said solidifying is progressing from said first section to said second section, wherein during said step of controlling, said deflection device is controlled such that said solidifying is progressing from said first section to said second section. By solidifying the first section of the selective part of the layer, the first section thermal resistance is reduces. Reducing the first thermal resistance may be beneficial for reducing the second section thermal resistance. A reduced second section thermal resistance increases the ability to conduct heat away from the second section, thereby allowing a relative short processing time while allowing to realize a relative high product quality. In other words, progressing from the first section to the second section avoids, or at least reduces, solidification of sections where heat may not be easily conducted away.

Preferably, said control device is further arranged for controlling said deflection device, during solidification of said selective part of said layer, such that said beam of electromagnetic radiation in said first section is moved over a first distance before changing a movement direction of said beam of said electromagnetic radiation and such that said beam of electromagnetic radiation in said second section is moved over a second distance, that is longer than said first distance, before changing a movement direction of said beam of said electromagnetic radiation, wherein during said step of controlling, said deflection device is controlled such that said beam of electromagnetic radiation in said first section is moved over said first distance before changing said movement direction of said beam of said electromagnetic radiation and such that said beam of electromagnetic radiation in said second section is moved over said second distance, that is longer than said first distance. A second distance that is longer than the first distance is beneficial for increasing time between thermal inputs for a section by using relative long scan paths. This is beneficial for realising a relative high product quality.

In an embodiment of the method according to the present disclosure, wherein said control device is further arranged for controlling said deflection device, during solidification of said selective part of said layer, such that a movement of said beam of electromagnetic radiation in said first section is delayed, by a first delay, when changing a movement direction of said beam of electromagnetic and such that a movement of said beam of electromagnetic radiation in said second section is delayed, by a second delay, that is longer than said first delay, when changing a movement direction of said beam of electromagnetic radiation, wherein during said step of controlling, said deflection device is controlled such that said movement of said beam of electromagnetic radiation in said first section is delayed, by said first delay, when changing said movement direction of said beam of electromagnetic radiation and such that said movement of said beam of electromagnetic radiation in said second section is delayed, by said second delay, that is longer than said first delay, when changing said movement direction of said beam of electromagnetic radiation. A second delay that is longer than the first delay is beneficial for increasing time between thermal inputs for a section by using relative long delays. A relative long delay allows more heat to be conducted away from the second section. This is beneficial for realising a relative high product quality.

Preferably, said control device is further arranged for controlling said deflection device, during solidification of said selective part of said layer, such that subsequent movements in different directions of said beam of electromagnetic radiation in said first section enclose a first angle and such that subsequent movements in different directions of said beam of electromagnetic radiation in said second section enclose a second angle that is larger than said first angle, wherein during said step of controlling, said deflection device is controlled such that subsequent movements in different directions of said beam of electromagnetic radiation in said first section enclose said first angle and such that subsequent movements in different directions of said beam of electromagnetic radiation in said second section enclose said second angle that is larger than said first angle. This is beneficial for reducing the heat rate input in parts of said second section and thereby realising a relative high product quality.

Preferably, said control device is further arranged for controlling said solidifying device and said deflection device, during solidification of said selective part of said layer, such that an energy density of said beam of electromagnetic radiation for said second section is lower than for said first section, wherein during said step of controlling, said deflection device is controlled such that said energy density of said beam of electromagnetic radiation for said second section is lower than for said first section. This is beneficial for realising a lower heat rate input in the second section that is smaller than a heat rate input in the first section and thereby for realising an object having a relative high quality.

Preferably, said control device is further arranged for controlling said solidifying device and said deflection device, during solidification of said selective part of said layer, such that a spot size and/or spot shape of said beam of electromagnetic radiation differs for said second section and said first section, wherein during said step of controlling, said deflection device is controlled such that said spot size, spot shape and/or hatch spacing differs for said second section and said first section. This is beneficial for realising a lower heat rate input in the second section that is smaller than a heat rate input in the first section and thereby for realising an object having a relative high quality.

In an embodiment of the method according to the second aspect of the present disclosure, wherein said apparatus is arranged for realizing a gas flow in a gas flow direction within said process chamber and said control device is further arranged for controlling said solidifying device and said deflection device, during solidification of said selective part of said layer, taking into account a direction of a gas flow in said process chamber, wherein during said step of controlling, said solidifying device and said deflection device are controlled taking into account said direction of said gas flow in said process chamber, preferably such that a predetermined heat rate input in said first section and said second section is realised independent of a movement direction of said beam of electromagnetic radiation along said surface level.

Preferably, said method further comprises the steps of:
calculating, by a calculating unit, process settings of said deflection device taking into account said first section thermal resistance and said second section thermal resistance, wherein said process settings comprise vectors for moving said beam of electromagnetic radiation along said surface level; and
receiving, by said control device, said process settings; and wherein, during said step of controlling, said control device is controlling said deflection device in accordance with said process settings.

In this regard, it is beneficial if said steps of calculating and receiving are performed before said steps of solidifying, moving and controlling, wherein during said step of solidifying a first selective layer-part of the powdered material is solidified for producing said object. Computing the process settings in advance during an offline simulation is beneficial for allowing to realise a relative short downtime before starting the manufacture of the object. In addition, an offline simulation allows for evaluating a plurality of strategies comprising different process parameters to arrive at process settings that allow to realise relative low manufacturing costs while allowing to realize a relative high product quality.

In an embodiment of the method according to the present disclosure, said method further comprises the steps of:
detecting, by a detection arrangement, a temperature of said selective part of said layer;
receiving, by said processor unit, said detected temperatures;
calculating, by a processing unit, updated process settings of said deflecting device based on said detected temperatures, preferably wherein said updated process settings comprise updated vectors for moving said beam of electromagnetic radiation along said surface level;
receiving, by said control device, said updated process setting; and wherein, during said step of controlling, said control device is controlling said deflecting device in accordance with said updated process settings.

Calculating updated process settings, during manufacturing of the object, based on a detected temperature is beneficial for avoiding or at least significantly reducing the risk of manufacturing an object with a relative low quality.

Preferably, during said step of solidifying, said first section of said selective part of said layer is solidified before said second section of said selective part of said layer is solidified.

Embodiments of the method and apparatus according to the present disclosure will next be explained by means of the accompanying schematic figures, wherein:

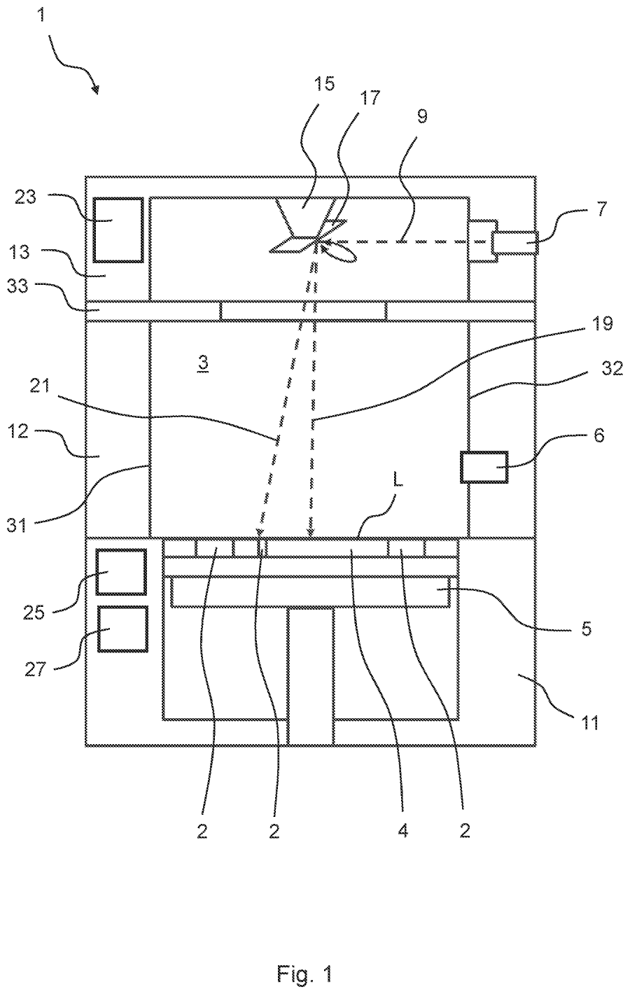

FIG. 1—shows a vertical cross section of an apparatus for producing an object by means of additive manufacturing according to the first aspect of the present disclosure;

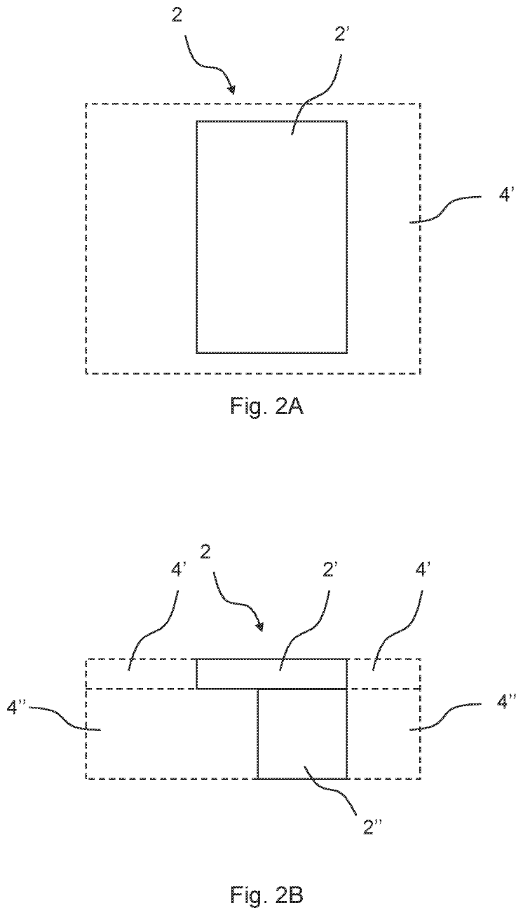

FIGS. 2A and 2B—show an object to be produced by means of additive manufacturing according to the present disclosure, in respectively a top view and a cross-sectional sideview;

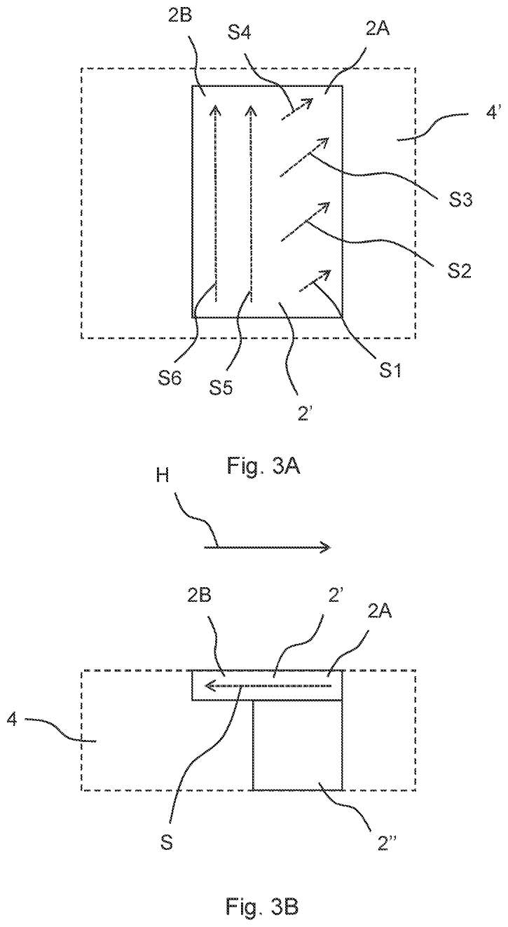

FIGS. 3A and 3B—show the scan paths of the top layer of the object of FIG. 2, in respectively a top view and a cross-sectional sideview;

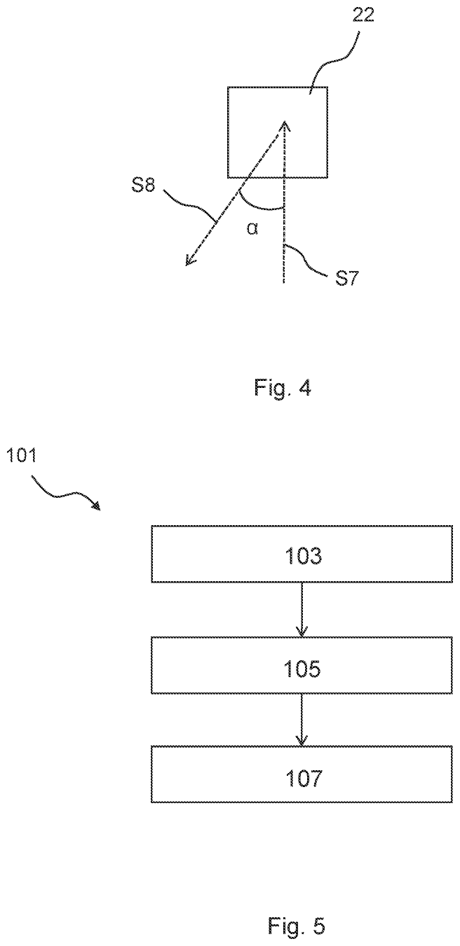

FIG. 4—shows two subsequent scan paths for a voxel of an object to be produced by means of additive manufacturing according to the present disclosure;

FIG. 5—shows a method of manufacturing an object by means of additive manufacturing according to a second aspect of the present disclosure;

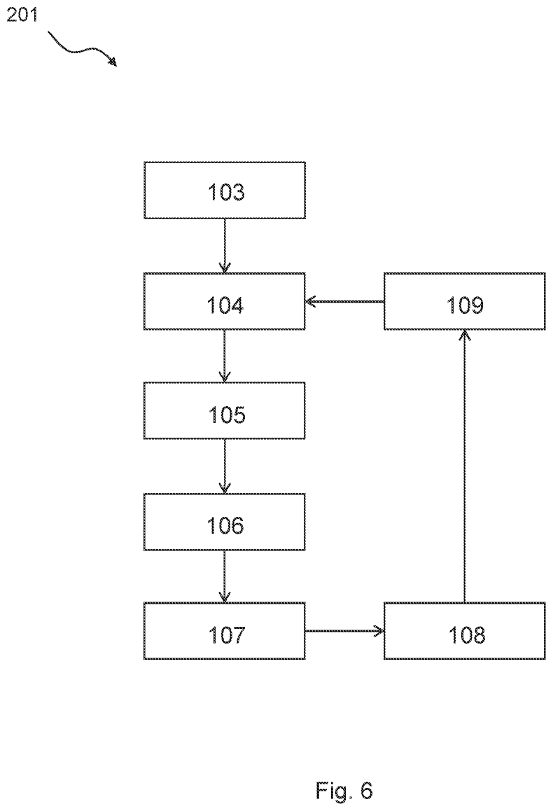

FIG. 6—shows another method of manufacturing an object by means of additive manufacturing according to a second aspect of the present disclosure.

FIG. 1 shows a vertical cross section of the apparatus 1 arranged for producing an object 2 by means of additive manufacturing. The apparatus 1 is built from several frame parts 11, 12, 13 and comprises a process chamber 3 for receiving a bath of powdered material 4 which can be solidified by exposure to electromagnetic radiation 9. The process chamber 3 is substantially air tight and is bounded at an upper side by an upper wall 33 through which electromagnetic radiation is allowed to enter the process chamber 3. The process chamber 3 is bounded at the four sides by side walls, of which only opposite side wall 31 and side wall 32 are shown. The bath of powdered material 4 is provided from a supply container (not shown). In a lower frame part 11 of the apparatus 1, a shaft is provided, wherein a support 5 is provided for positioning one or more parts of the object 2 to be produced, in relation to the surface level L of the bath of powdered material 4. The distance between the upper wall 33 and the surface level L is constant. The support 5 is movably provided in the shaft, such that after solidifying a layer of the object 2, the support 5 is lowered.

In a top part 13 of the apparatus 1, a solidifying device 7 is provided for generating a beam of the electromagnetic radiation 9 for solidifying a selective part of a layer of the powdered material 4. In the embodiment shown, the solidifying device 7 is a laser device, which is arranged for producing electromagnetic radiation 9 in the form of laser light, in order to melt the powdered material 4 provided on the support 5. The electromagnetic radiation 9 emitted by the laser device 7 is deflected by means of a deflection device 15. The deflection device 15 uses a rotatable optical element 17 to move the beam of electromagnetic radiation 9 along the surface L of the part of layer of the powdered material 4. Depending on the position of the rotatable optical element 17 of the deflection device 15, the electromagnetic radiation is emitted, as an example, according to radiation rays 19, 21, thereby defining a scan path at the surface level L. The apparatus 1 comprises a control device 23 for controlling the laser device 7 and the deflection device 15, during solidification of the selective part of the layer of the powdered material 4. The apparatus 1 is provided with an opening 6 arranged for providing or flushing an inert gas such as argon or nitrogen into or through the process chamber 3.

The apparatus 1 further comprises a detection arrangement 25, for detecting a temperature of the selective part of the layer 2′, and a processor unit 27, for receiving the detected temperature and for calculating updated process settings of the laser device 7 and/or the deflection device 15 for solidifying the selective part of the layer 2′ based on the detected temperature. The control device 23 is arranged for receiving the updated process settings and controlling the laser device 7 and deflection device 15 for solidifying the selective part of the layer 2′ in accordance with the updated process settings.

The object 2, as for example shown in FIGS. 2A and 2B, is produced layer by layer. A first layer of powdered material 4 is provided on the support 5. A selective part of the layer of powdered material 4 is exposed by the electromagnetic radiation 9, in order to melt the respective powdered material 4. After cooling, a solidified part of the object 2 to be produced is formed. After forming the first layer of the object 2 to be produced, the support 5 is lowered and a subsequent layer of powdered material 4 is provided on top of the first layer, wherein the first layer comprises the first layer of the object 2 already formed and powdered material 4 that is not solidified previously. A subsequent layer of the object 2 to be produced is solidified in the subsequent layer of powdered material 4. A subsequent layer 2′ of the object 2 is produced accordingly, in the layer of powdered material 4′ on the top of the layers 2″ of the object 2 already formed and on top of the layers of powdered material 4″ that is not solidified previously. Eventually, the object 2 to be produced is formed. Heat control is necessary for each section of the selective part of a layer for cooling of the melted powdered material in order to solidify respective parts of the object 2. Poor heat control causes many undesirable effects such as out of plan growth, warping of parts, and limitation on objects that can be produced.

The selective part of the subsequent layer 2′ of the object 2 to be solidified, is located partly on top of the layers 2″ of the object 2 already solidified previously, and partly on top of the powdered material 4″, not solidified previously as it is no part of the of the object 2 to be produced. The thermal resistance of the powdered material 4′ and 4″ is higher than the thermal resistance of the solidified material 2″. This means that heat is conducted more easily away from a part of the object 2, that is located adjacent to or directly above a part of the object 2 already solidified than from a layer 2′ of the object 2 that is directly resting on a lower side thereof on powdered material 4″

During solidification of a selective part 2′ of the layer of the powdered material 4′, the control device 23 controls the laser device 7 and the deflection device 15, taking into account the thermal resistance of a first section 2A, for conducting heat away from the first section 2A, and taking into account the thermal resistance of a second section, for conducting heat away from the second section. The thermal resistance of the second section 2B is higher than the thermal resistance of the first section 2A, which means that heat is more easily conducting away from the first section 2A than from the second section 2B. The thermal resistances of the first section 2A and the second section 2B are based on the thermal resistance of the powdered material 4 and the thermal resistance of the already realised parts of the object 2.

An example of producing an object 2 according to the present disclosure is shown in FIGS. 3A and 3B. FIG. 3A shows schematically a top view of the top layer 2′ of the object 2 to be produced as show schematically in the cross-sectional side view of FIG. 3B. The dashed arrowed lines indicate the respective scan paths for the layer 2′ of the object 2 to be produced. The control device 23 controls the laser device 7 and the deflection device 15 in such a way, that the beam of electromagnetic radiation 9, and thereby the solidification, is progressing from the first section 2A, with low thermal resistance, to the second section 2B, which high thermal resistance, as indicated by the arrow S. At the right side of the arrow S, the thermal resistance is lowest, at least lower than at the left side of the arrow S. As the scan path is progressing in the direction of the arrow S, the thermal resistance increases. A part of the heat generated in second section 2B is directed in a heat flow direction H from the second section 2B towards the first section 2A, in opposite direction of the scan path indicated by arrow S.

For the layer 2′ to be produced, the beam of electromagnetic radiation 9 is first moved over a first distance in a zig-zig pattern, as subsequently indicated by arrows S1-S4 in FIG. 3A. A zig-zig pattern is to be understood as a pattern wherein neighboring scan paths are progressing in the same direction. When the first section 2A of the layer 2′ is produced, the movement direction of the beam of electromagnetic radiation 9 is changed such that the beam of electromagnetic radiation 9 is moved in a second direction in a zig-zig pattern, as indicated by subsequent arrows S5 and S6. Each layer of the object 2 may be divided in a plurality of sections. For realizing good heat control, each section of said plurality of sections needs sufficient time to cool down after solidifying. Using long scan paths results in increased time between thermal inputs per section and thus realizes good heat control. Alternatively, the beam of electromagnetic radiation 9 may progress away from the first section 2A in an zig-zag pattern, i.e. a pattern wherein neighboring scan paths are progressing in an opposite direction.

Another way to achieve an increase in time between thermal input per given section of said plurality of sections according to the present disclosure is by controlling the deflection device 15, during solidification of the selective part of the layer 2′, such that the movement of the beam of electromagnetic radiation 9 in the first section 2A is delayed, by a first delay, and such that a movement of the beam of electromagnetic radiation 9 in the second section 2B is delayed, by a second delay, that is longer than the first delay. Related to FIG. 3B, the delay increases opposite to the direction of the heat flow H. This results in a long second delay in the left section of layer 2′ to be produced, as in this portion the thermal resistance is highest. Accordingly, this results in a short first delay, at least shorter than the second delay, in the right section of the of layer 2′ to be produced. The control device 23 can control the delay for the different sections for example, by waiting for a predetermined time before solidifying another section of the plurality of sections, or by solidifying another remote section of the layer 2′ prior to continuing solidifying a current section of the plurality of sections.

Yet another way for heat control is by controlling the laser device 7 and the deflection device 15, during solidification of the selective part of the layer 2′, such that an energy density of the beam of electromagnetic radiation 9 for the second section 2B is lower than for the first section 2A. This can for example be achieved by varying the spot shape or spot size of the beam of electromagnetic radiation 9. The control device 23 controls the energy density of the beam of electromagnetic radiation 9 by controlling the power of the laser 7 and/or the scan speed of the beam of electromagnetic radiation 9 at the surface level L. By applying low laser power and low scan speed in the second section 2B, where the thermal resistance is high, the second section 2B has sufficient time for cooling down. Accordingly, the laser power and/or scan speed in the first section 2A can be higher than in the second section 2B.

FIG. 4 shows two subsequent scan paths S7 and S8 for solidifying a part of section 22 of an object 2 according to the present disclosure. The two subsequent movements of the beam of electromagnetic radiation 9 that correspond with scan paths S8 and S9, enclose an angle α. When the angle α is relative small, the scan path S9 overlaps scan path S8 at least partly due to the width of the beam of electromagnetic radiation 9 at the surface level L. The smaller the angle α, the more the two subsequent scan paths S8 and S9 overlap. This results in higher a thermal input energy in the respective section 22. To avoid too high thermal input per given section, the control device 23 is arranged for controlling the deflection device 15, during solidification of the selective part of the layer 2′, such that the movement of the beam of electromagnetic radiation 9 is delayed, when the angle α is smaller than a predetermined angle.

Furthermore, in order to achieve an increase in time between thermal input per given spatial voxel according to the present disclosure, the control device 23 is arranged for controlling the deflection device 15, during solidification of the selective part of the layer, such that subsequent movements in different directions of the beam of electromagnetic radiation 9 in the first section 2A enclose a first angle α and such that subsequent movements in different directions of the beam of electromagnetic radiation 9 in the second section 2B enclose a second angle α that is larger than the first angle α.

Additionally, the apparatus 1 is arranged for realizing a gas flow in a gas flow direction within the process chamber 3, by providing the gas through the opening 6 into or through the process chamber 3. In an additional way to achieve an increase in time between thermal input per section according to the present closure, the control device 23 is arranged for controlling the laser device 7 and the deflection device 15, during solidification of the selective part of the layer 2′, taking into account the gas flow direction of the gas flow in the process chamber 3 such that, during manufacturing of the object 2, a predetermined heat rate input in the first section 2A and the second section 2B is realised independent of a movement direction of the beam of electromagnetic radiation 9 along the surface level L.

FIG. 5 shows a method 101 for manufacturing an object 2 by means of additive manufacturing using the apparatus 1 as described previously. In a first step of solidifying 103, the selective part of the layer of the powdered material 4 is solidified by the laser device. During the step of moving 105, the beam of electromagnetic radiation 9 is moved along the surface level L according to the respective scan path, by the deflection device 15. Subsequently, during a step of controlling 107 of the method 101, the laser device 7 and the deflection device 15 are controlled by the control device 23, taking into account a first section 2A thermal resistance for conducting heat away from a first section 2A of the selective part of the layer and a second section 2B thermal resistance, that is higher than the first section 2A thermal resistance, for conducting heat away from a second section 2B of the selective part of the layer.

During the step of controlling 107, the control device 23 is arranged to control the laser device 7 and/or the deflection device 15 in order to achieve the different ways to achieve an increase in time between thermal input per given section, as described previously.

FIG. 6 shows another method 201 for manufacturing an object 2 by means of additive manufacturing using the apparatus 1 as described above. The method 201, comprises the step of solidifying 103, the step of moving 105, and the step of controlling 107, as described previously for method 101.

Prior to the step of moving 105, the method 201 further comprises the step of calculating 104 process settings of the deflection device 15 taking into account the first section 2A thermal resistance and the second section 2B thermal resistance, by using one or more of the proposed ways to achieve an increase in time between thermal input per section. The step of calculating 104 is executed by a calculating unit comprised in the processor unit 27. The process settings comprise vectors for moving the beam of electromagnetic radiation 9 along the surface level L. After the step of moving 105 and prior to the step of controlling 107, the process settings are received by the control device 23 during a step of receiving 106, after which, during the step of controlling 107, the control device 23 controls the deflection device 15 in accordance with the process settings.

After controlling 107 the deflection device 15 in accordance with the process settings, a temperature of the selective part of the layer 2′ is measured by the detection arrangement 25, during a step of detecting 108. During a step of receiving 109, the detected temperature is received by the processor unit 27, after which updated process settings of the deflecting device 15 based on the detected temperatures are calculated during the step of calculating 104, wherein the updated process settings comprise updated vectors for moving the beam of electromagnetic radiation 9 along the surface level L. The updated process setting are received during the step of receiving 106, and during the step of controlling 107, the control device 23 is controlling the deflecting device 15 in accordance with the updated process settings.

The loop of the steps of respectively calculating 104, moving 105, receiving 106, controlling 107, detecting 108, and receiving 109 is cyclically repeated until the object 2 is produced.

1-15. (canceled)

16. An apparatus for producing an object by additive manufacturing layer by layer in a layer sequence, comprising:
a process chamber configured to receive a bath of powdered material configured to be solidified by exposure to electromagnetic radiation;
a support configured to position a part of the object in relation to a surface level of the bath of powdered material;
a solidifying device configured to generate a beam of electromagnetic radiation for solidifying a selective part of a layer of the powdered material;
a deflection device configured to move the beam of electromagnetic radiation along the surface level; and
a controller configured to control the solidifying device and the deflection device, during solidification of the selective part of the layer, considering a first section thermal resistance for conducting heat away from a first section of the selective part of the layer and a second section thermal resistance, greater than the first section thermal resistance, for conducting heat away from a second section of the selective part of the layer.

17. The apparatus according to claim 16, wherein the controller is configured to control the deflection device, during solidification of the selective part of the layer, such that the solidifying progresses from the first section to the second section.

18. The apparatus according to claim 16, wherein the controller is configured to control the deflection device, during solidification of the selective part of the layer, such that the beam of electromagnetic radiation in the first section is moved over a first distance before changing a movement direction of the beam of the electromagnetic radiation, and such that the beam of electromagnetic radiation in the second section is moved over a second distance, longer than the first distance, before changing a movement direction of the beam of the electromagnetic radiation.

19. The apparatus according to claim 16, wherein the controller is configured to control the deflection device, during solidification of the selective part of the layer, such that a movement of the beam of electromagnetic radiation in the first section is delayed, by a first delay, when changing a movement direction of the beam of electromagnetic radiation, and such that a movement of the beam of electromagnetic radiation in the second section is delayed, by a second delay, longer than the first delay, when changing a movement direction of the beam of electromagnetic radiation.

20. The apparatus according to claim 19, wherein the second delay exceeds a predetermined delay.

21. The apparatus according to claim 16, wherein the controller is configured to control the deflection device, during solidification of the selective part of the layer, such that subsequent movements of the beam of electromagnetic radiation in the first section enclose an angle, and wherein the movement of the beam of electromagnetic radiation in the first section is delayed, when the angle is less than a predetermined angle.

22. The apparatus according to claim 16, wherein the first and second section thermal resistance are based on a thermal resistance of the bath of material and a thermal resistance of the part of the object.

23. The apparatus according to claim 16, wherein the controller is configured to control the solidifying device and the deflection device, during solidification of the selective part of the layer, such that an energy density of the beam of electromagnetic radiation for the second section is less than an energy density of the beam of electromagnetic radiation for the first section.

24. The apparatus according to claim 23, wherein the energy density of the beam of electromagnetic radiation for the second section is less than a predetermined energy density.

25. The apparatus according to claim 23, wherein at least one of a spot shape, a spot size, and a hatch spacing of the beam of electromagnetic radiation for the first section is different from the second section.

26. The apparatus according to claim 16, wherein the apparatus is configured to achieve a gas flow direction within the process chamber, and wherein the controller is further configured to control the solidifying device and the deflection device, during solidification of the selective part of the layer, considering the gas flow direction in the process chamber such that, during manufacturing of the object, a predetermined heat rate input in the first section and the second section is achieved independent of a movement direction of the beam of electromagnetic radiation along the surface level.

27. A method of manufacturing an object by additive manufacturing layer by layer in a layer sequence, using an apparatus comprising:
a process chamber configured to receive a bath of powdered material configured to be solidified by exposure to electromagnetic radiation;
a support configured to position a part of the object in relation to a surface level of the bath of powdered material;
a solidifying device configured to generate a beam of electromagnetic radiation configured to solidify a selective part of a layer of the powdered material;
a deflection device configured to move the beam of electromagnetic radiation along the surface level; and
a controller configured to control the solidifying device and the deflection device, during solidification of the selective part of the layer, considering a first section thermal resistance for conducting heat away from a first section of the selective part of the layer and second section thermal resistance, greater than the first section thermal resistance, for conducting heat away from a second section of the selective part of the layer;
wherein the method comprises the steps of:
solidifying, by the solidifying device, the selective part of the layer of the powdered material;
moving, by the deflection device, the beam of electromagnetic radiation along the surface level; and
controlling, by the controller, the solidifying device and the deflection device, considering the first section thermal resistance for conducting heat away from a first section of the selective part of the layer and second section thermal resistance, greater than the first section thermal resistance, for conducting heat away from a second section of the selective part of the layer.

28. The method according to claim 27, wherein the controller is configured to control the deflection device, during solidification of the selective part of the layer, such that the solidifying progresses from the first section to the second section, and wherein during the step of controlling, the deflection device is controlled such that the solidifying progresses from the first section to the second section.

29. The method according to claim 27, wherein the controller is configured to control the deflection device, during solidification of the selective part of the layer, such that the beam of electromagnetic radiation in the first section is moved over a first distance before changing a movement direction of the beam of the electromagnetic radiation, and such that the beam of electromagnetic radiation in the second section is moved over a second distance, greater than the first distance, before changing a movement direction of the beam of the electromagnetic radiation, and wherein during the step of controlling, the deflection device is controlled such that the beam of electromagnetic radiation in the first section is moved over the first distance before changing the movement direction of the beam of the electromagnetic radiation, and such that the beam of electromagnetic radiation in the second section is moved over the second distance, greater than the first distance.

30. The method according to claim 27, wherein the controller is further configured to control the deflection device, during solidification of the selective part of the layer, such that a movement of the beam of electromagnetic radiation in the first section is delayed, by a first delay, when changing a movement direction of the beam of electromagnetic radiation and such that a movement of the beam of electromagnetic radiation in the second section is delayed, by a second delay, that is greater than the first delay, when changing a movement direction of the beam of electromagnetic radiation, wherein during the step of controlling, the deflection device is controlled such that the movement of the beam of electromagnetic radiation in the first section is delayed, by the first delay, when changing the movement direction of the beam of electromagnetic radiation and such that the movement of the beam of electromagnetic radiation in the second section is delayed, by the second delay, longer than the first delay, when changing the movement direction of the beam of electromagnetic radiation.

31. The method according to claim 27, wherein the controller is further configured to control the deflection device, during solidification of the selective part of the layer, such that subsequent movements in different directions of the beam of electromagnetic radiation in the first section enclose a first angle, and such that subsequent movements in different directions of the beam of electromagnetic radiation in the second section enclose a second angle that is greater than the first angle, wherein during the step of controlling, the deflection device is controlled such that subsequent movements in different directions of the beam of electromagnetic radiation in the first section enclose the first angle, and such that subsequent movements in different directions of the beam of electromagnetic radiation in the second section enclose the second angle that is greater than the first angle.

32. The method according to claim 27, wherein the controller is configured to control the solidifying device and the deflection device, during solidification of the selective part of the layer, such that an energy density of the beam of electromagnetic radiation for the second section is less than an energy density of the beam of the electromagnetic radiation for the first section, and wherein during the step of controlling, the deflection device is controlled such that the energy density of the beam of electromagnetic radiation for the second section is less than for the first section.

33. The method according to claim 27, wherein the apparatus is configured to achieve a gas flow direction within the process chamber and the controller is configured to control the solidifying device and the deflection device, during solidification of the selective part of the layer, considering the gas flow direction in the process chamber, wherein during the step of controlling, the solidifying device and the deflection device are controlled considering the gas flow direction in the process chamber.

34. The method according to claim 33, wherein a predetermined heat rate input in the first section and the second section is achieved independent of a movement direction of the beam of electromagnetic radiation along the surface level.
